(19) United States
(12) Patent Application Publication
(10) Pub. No.: US 2026/0118963 A1
(43) Pub. Date: Apr. 30, 2026

(54) ELECTRONIC DEVICE

(71) Applicant: CARUX TECHNOLOGY PTE. LTD., SINGAPORE (SG)

(72) Inventors: Yuan-Fu Lin, Tainan (TW); Hsien-Chang Chen, Tainan (TW); Ming-Hong Yao, Tainan (TW)

(73) Assignee: CARUX TECHNOLOGY PTE. LTD., SINGAPORE (SG)

(21) Appl. No.: 19/290,375

(22) Filed: Aug. 5, 2025

(30) Foreign Application Priority Data
Sep. 30, 2024 (CN) 202411379390.8

(51) Int. Cl. G06F 3/01; G06F 3/041

(52) U.S. Cl. CPC G06F 3/016; G06F 3/04166; G06F 3/04182

(57) ABSTRACT

An electronic device is provided. The electronic device includes a vibrator, a display panel, a touch element and a control circuit. The display panel is arranged on the vibrator. The touch element is arranged on the display panel. The control circuit generates a driving signal according to the touch signal provided by the touch element. The vibrator generates vibration according to the driving signal. The driving signal includes a first part and a second part. The first part includes the maximum absolute voltage value. The second part includes the minimum absolute voltage value. In the same time interval, the relative voltage variation of the first part is greater than the relative voltage variation of the second part.

### CROSS-REFERENCE TO RELATED APPLICATION

This application claims the priority benefit of China application serial no. 202411379390.8, filed on Sep. 30, 2024. The entirety of the above-mentioned patent application is hereby incorporated by reference herein and made a part of this specification.

### BACKGROUND

### Technical Field

The disclosure relates to an electronic device, particularly an electronic device with touch vibration effects.

### Description of Related Art

An electronic device may have touch vibration effects. The vibration of the electronic device may be provided by a vibrator. However, the larger the amplitude of the vibration of the current vibrator, the more noise the electronic device generates, thereby reducing the user's experience. Therefore, how to reduce the noise generated by the vibration of the vibrator in the electronic device is one of the research focuses of those skilled in the art.

### SUMMARY

The present disclosure provides an electronic device that may reduce the noise generated by the vibration of the vibrator in the electronic device itself.

According to an embodiment of the present disclosure, the electronic device includes at least one vibrator, a display panel, a touch element and a control circuit. The display panel is arranged on the at least one vibrator. The touch element is arranged on the display panel. The control circuit is electrically connected to the at least one vibrator and the touch element. The control circuit generates a driving signal based on the touch signal provided by the touch element. The at least one vibrator generates vibration according to the driving signal. The driving signal includes a first part and a second part. The first part includes the maximum absolute voltage value. The second part includes the minimum absolute voltage value. In the same time interval, the relative voltage variation of the first part is greater than the relative voltage variation of the second part.

The driving signal includes a first part and a second part. The second part determines the level of collision between the vibrator and an object in the electronic device. The first part determines the vibration amplitude of the vibrator. Based on the above, the relative voltage variation of the second part is smaller than the relative voltage variation of the first part. The level of collision between the vibrator and the object is reduced. Therefore, the noise generated by the vibration of the vibrator in the electronic device itself may be reduced. As a result, the user's experience may be improved.

### BRIEF DESCRIPTION OF THE DRAWINGS

FIG. 1 is a schematic diagram illustrating an electronic device and a driving signal according to an embodiment of the disclosure.

FIG. 2 is a schematic diagram illustrating a vibrator and a driving signal according to an embodiment of the disclosure.

FIG. 3A to FIG. 3D are schematic diagrams illustrating the arrange of the vibrator according to an embodiment of the disclosure, respectively.

FIG. 4A to FIG. 4C are waveform diagrams of the driving signal according to an embodiment of the disclosure, respectively.

FIG. 5 is a waveform diagram of the driving signal according to an embodiment of the disclosure.

FIG. 6 is a waveform diagram of the driving signal according to an embodiment of the disclosure.

FIG. 7 is a waveform diagram of the driving signal according to an embodiment of the disclosure.

FIG. 8 is a schematic diagram illustrating a vibrator and a control circuit according to an embodiment of the disclosure.

FIG. 9 is a schematic diagram illustrating a vibrator and a control circuit according to an embodiment of the disclosure.

### DESCRIPTION OF THE EMBODIMENTS

The present disclosure may be understood through the following detailed description in conjunction with the accompanying drawings as described below. It should be noted that, for the purpose of clear illustration and easy understanding by readers, parts of the electronic devices are shown in each drawing of the present disclosure and some elements in each drawing may not be drawn to scale. Furthermore, the number and dimensions of each device shown in the drawings are illustrative only and are not intended to limit the scope of the present disclosure.

Certain terminology is used throughout the description and the following claims to refer to particular elements. As one skilled in the art will understand, electronic device manufacturers may refer to elements by different names. This document does not intend to distinguish between elements that differ in name but not in function. In the following description and in the claims, the terms “include,” “including,” and “have” are used in an open-ended manner, and thus should be interpreted to mean “including, but not limited to . . . ” Therefore, when the terms “include,” “including,” and/or “have” are used in the description of this disclosure, it will indicate the presence of corresponding features, regions, steps, operations and/or elements, but is not limited to the presence of one or more corresponding features, regions, steps, operations and/or elements.

It should be understood that when an element is referred to as being “coupled to,” “connected to,” or “in electrical communication with” another element, the element may be directly connected to the other element and may establish direct electrical connection, or there may be intermediate elements between these elements for relaying electrical connection (indirect electrical connection). In contrast, when an element is referred to as being “directly coupled to,” “directly in electrical communication with,” or “directly connected to” another element, there are no intermediate elements present.

Although terms such as first, second, third, etc. may be used to describe various elements, these elements are not limited by these terms. These terms are only used to distinguish one element from other elements in the specification. The claims may not use the same terms, but may use terms such as first, second, third, etc. relative to the order in which the elements are claimed. Therefore, in the following description, a first element may be a second element in the claims.

The electronic devices disclosed herein may include display devices, antenna devices, sensing devices, illumination devices, touch displays, curved displays, or free shape displays, but are not limited to these. The electronic devices may include foldable or flexible electronic devices. The electronic devices may, for example, include liquid crystal, light-emitting diodes, Quantum dots (QD), fluorescence, phosphor, other suitable display media, or combinations of the above, but are not limited to these. The light-emitting diodes may, for example, include organic light emitting diodes (OLED), mini LEDs, micro LEDs, or quantum dot LEDs (which may include QLED, QDLED), or other suitable materials, or combinations thereof, but are not limited to these. The display devices may, for example, include tiled display devices, but are not limited to these. The antenna devices may, for example, be liquid crystal antennas, but are not limited to these. The antenna devices may, for example, include antenna tiling devices, but are not limited to these. It should be noted that the electronic devices may be any combination of the aforementioned, but are not limited to these. Furthermore, the shape of the electronic devices may be rectangular, circular, polygonal, with curved edges, or other suitable shapes. The electronic devices may have peripheral systems such as driving systems, control systems, light source systems, etc. to support the display devices, antenna devices, or tiling devices, but this disclosure is not limited to these. The sensing devices may include cameras or infrared sensors or fingerprint sensors, etc., but this disclosure is not limited to these. In some embodiments, the sensing devices may also include flash, infrared (IR) light sources, other sensors, electronic elements, or combinations thereof, but are not limited to these.

In this disclosure, embodiments use “pixel” or “pixel unit” as a unit for describing a specific area containing at least one functional circuit for at least one specific function. The area of a “pixel” depends on the unit used to provide a specific function, and adjacent pixels may share the same parts or wires, but may also include their own specific parts. For example, adjacent pixels may share the same scan line or the same data line, but pixels may also have their own transistors or capacitors.

It should be noted that the technical features in the different embodiments described below may be replaced, recombined, or mixed with each other to form another embodiment without departing from the spirit of this disclosure.

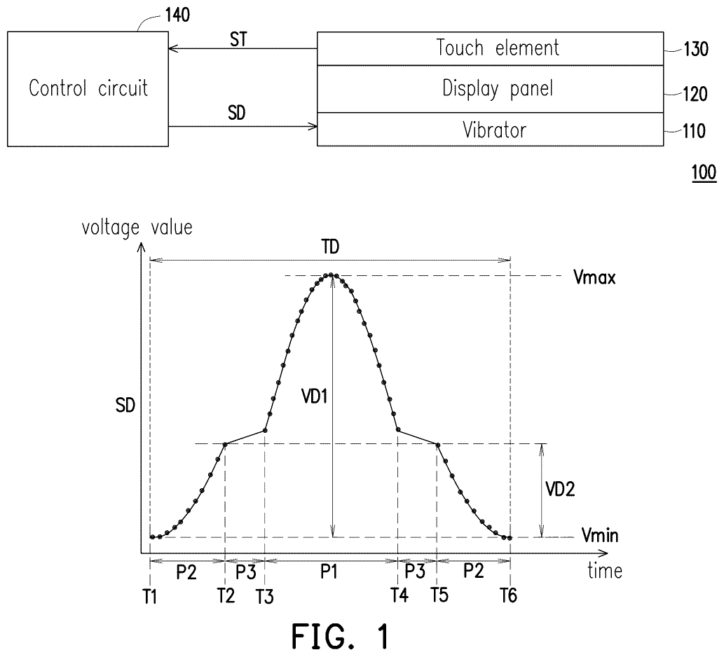

Please refer to FIG. 1, FIG. 1 is a schematic diagram of an electronic device and driving signals according to an embodiment of the disclosure. In the embodiment, the electronic device 100 includes a vibrator 110, a display panel 120, a touch element 130 and a control circuit 140. The display panel 120 is arranged on the vibrator 110. The touch element 110 is arranged on the display panel 120.

For example, the touch element 130 may be deposited on a first surface of the display panel 120 or embedded in the display panel 120. A second surface of the display panel 120 is located on the vibrator 110. The second surface is opposite to the first surface, but the disclosure is not limited thereto.

In the embodiment, the control circuit 140 is electrically connected to the vibrator 110 and the touch element 130. The control circuit 140 generates a driving signal SD based on the touch signal ST provided by the touch element 130. The control circuit 140 provides the driving signal SD to the vibrator 110. The vibrator 110 generates vibration according to the driving signal SD generated based on the touch signal ST.

In the embodiment, the driving signal SD includes a first part P1 and a second part P2. The first part P1 includes the maximum absolute voltage value. The maximum absolute voltage value is, for example, the absolute value of the maximum voltage value Vmax of the driving signal SD (for example, |Vmax|). The second part P2 includes the minimum absolute voltage value. The minimum absolute voltage value is, for example, the absolute value of the minimum voltage value Vmin of the driving signal SD (for example, |Vmin|). For example, the minimum voltage value Vmin is approximately equal to 0 volt, but the disclosure is not limited thereto. Within a same time interval TD, the relative voltage variation VD1 of the first part P1 is greater than the relative voltage variation VD2 of the second part P2.

Furthermore, the time interval TD is the period of the driving signal SD. Within a single period of the driving signal SD, the second part P2 of the driving signal SD is provided from a time point T1 to a time point T2. The second part P2 has a relative voltage variation VD2. The first part P1 of the driving signal SD is provided from a time point T3 to a time point T4. The first Part P1 has a relative voltage variation VD1. The relative voltage variation VD1 is greater than the relative voltage variation VD2. The second Part P2 of the driving signal SD is also provided from a time point T5 to a time point T6.

It should be noted, the second part P2 determines a level of collision between the vibrator 110 and an object in the electronic device 100. The first part P1 determines a vibration amplitude of the vibrator 110. Based on the above, the relative voltage variation VD2 of the second part P2 is smaller than the relative voltage variation VD1 of the first part P1. Therefore, the level of collision between the vibrator 110 and the object is reduced. Therefore, the noise generated by the electronic device 100 itself due to the vibration of the vibrator 110 may be reduced. In this way, experience of the electronic device 100 for the user may be improved.

In the embodiment, the driving signal SD further includes a third part P3. The third part P3 is a connecting part located between the first part P1 and the second part P2. In a single period of the driving signal SD, the third part P3 of the driving signal SD is provided from the time point T2 to the time point T3. The third part P3 of the driving signal SD is also provided from the time point T4 to the time point T5. In the embodiment, the voltage value of the third part P3 variations with time. In other words, a slope of the voltage value of the third part P3 with respect to time is not equal to 0. In some embodiments, the voltage value of the third part P3 may not variation with time. In other words, the slope of the voltage value of the third part P3 with respect to time is equal to 0.

In some embodiments, the driving signal SD may not include the third part P3. In other words, the time point T2 is the same as the time point T3. The time point T4 is the same as the time point T5.

For the purpose of illustration, the embodiment uses one vibrator 110 as an example. The disclosure is not limited by the number of vibrators. In some embodiments, the electronic device 100 may include multiple vibrators.

In the embodiment, the display panel 120 may be a display that provides a display screen using liquid crystal, light-emitting diode, Quantum dot, fluorescence, phosphorescence, or other suitable display media. The touch element 130 may be a capacitive touch circuit, a resistive touch circuit, virtual buttons on the display panel 120, or physical buttons.

In the embodiment, the first part P1 may be one of a sine wave (that is, sin (2π×f×t)), squared sine waves (that is, sin²(2π×f×t)), a triangle wave and a step wave. The second part P2 may be one of the sine wave, the squared sine wave, the triangle wave and the step wave.

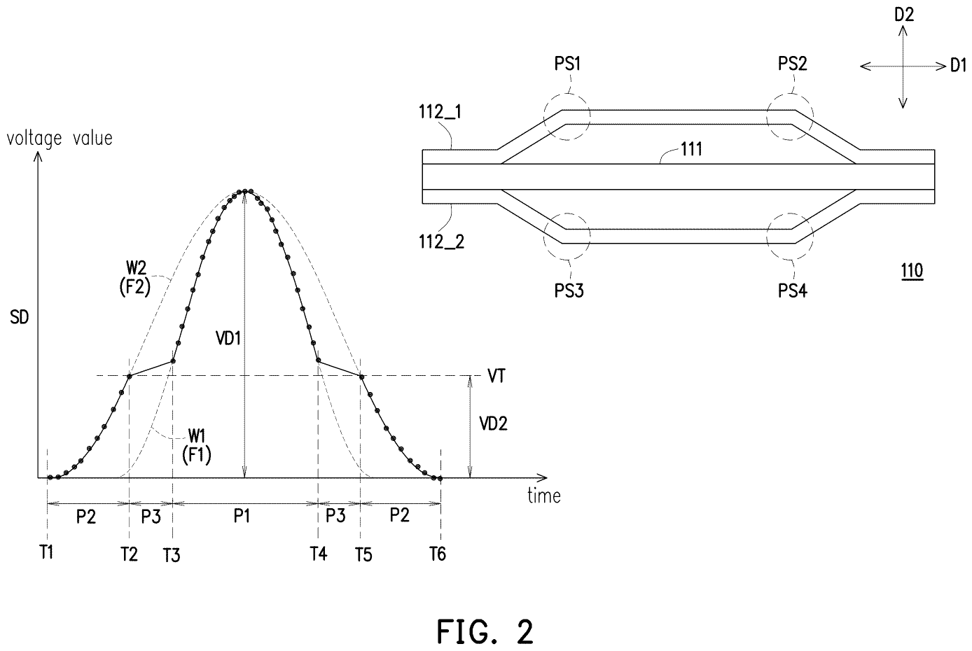

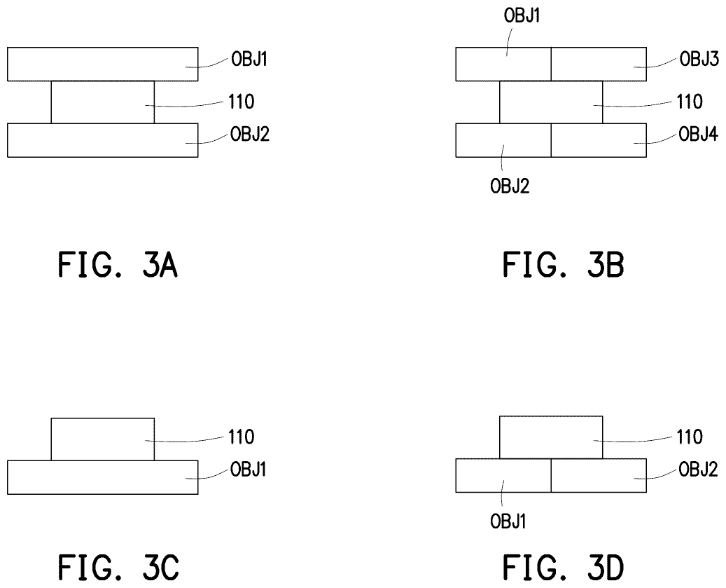

Please refer to FIG. 1, FIG. 2 and FIG. 3A. FIG. 2 is a schematic diagram of the vibrator and driving signal according to an embodiment of the disclosure. FIG. 3A is a schematic diagram of the arrange of the vibrator according to an embodiment of the disclosure. In the embodiment, the vibrator 110 includes a piezoelectric element 111 and vibrating reeds 112_1 and 112_2, but the disclosure is not limited to this configuration of the vibrator 110. The vibrating reed 112_1 is fixed at both terminals to the first side of the piezoelectric element 111. The vibrating reed 112_2 is fixed at both terminals to the second side of the piezoelectric element 111. The second side is opposite to the first side. The piezoelectric element 111 extends and contracts along a direction D1 according to the driving signal SD. Therefore, the Vibrating reeds 112_1 and 112_2 vibrate along a direction D2.

In the embodiment, when the vibrating reeds 112_1 and 112_2 are vibrating, the collision positions PS1 and PS2 of the vibrating reed 112_1 collide with an object OBJ1 of the electronic device 100. The collision positions PS3 and PS4 of the vibrating reed 112_2 collide with an object OBJ2 of the electronic device 100. The objects OBJ1 and OBJ2 may be, for example, a Part of the display panel 120 or a load with a specific weight. After the collision, the vibrating reeds 112_1 and 112_2 respectively contact the objects OBJ1 and OBJ2 and move the objects OBJ1 and OBJ2. Therefore, the objects OBJ1 and OBJ2 are able to move along the direction D2.

In the second part P2, when the voltage value rises rapidly between the time points T1 and T2, the noise caused by the collision between the collision positions PS1 to PS4 of the vibrating reeds 112_1 and 112_2 and the objects OBJ1 and OBJ2 of the electronic device 100 would be greater. When the voltage value rises slowly between the time points T1 and T2, the Noise caused by the collision between the collision positions PS1 to PS4 of the vibrating reeds 112_1 and 112_2 and the objects OBJ1 and OBJ2 of the electronic device 100 would be smaller.

In the first part P1, the maximum voltage value Vmax determines the feedback tactile sensation (for example, the amount of vibration).

The driving signal SD includes a first part P1, a second part P2 and a third part P3. In the embodiment, the relative voltage variation VD2 equals the voltage difference between the voltage value VT and the minimum voltage value Vmin. Therefore, the voltage value VT limits the collision force of the vibrating reeds 112_1 and 112_2. The noise will not be increased. Furthermore, after the collision, the first part P1 is generated to determine the displacement amount of the objects OBJ1 and OBJ2 moved by the vibrating reeds 112_1 and 112_2.

In the embodiment, the first frequency F1 of the first part P1 is higher than the second frequency F2 of the second part P2. Therefore, the frequency at which the collision positions PS1 to PS4 of the Vibrating reeds 112_1 and 112_2 collide with the objects OBJ1 and OBJ2 of the electronic device 100 is also lower. In the embodiment, the first part P1 may be generated by a sine wave W1 having the first frequency F1. The second part P2 may be generated by a sine wave W2 having the second frequency F2. For Example, the first frequency F1 is higher than or equal to 1.5 times the second frequency F2. For Example, the second frequency F2 may be 50 Hz. The first frequency F1 is higher than or equal to 75 Hz.

In the embodiment, the first part P1 may include one or more sine wave W1.

In the embodiment, the sine waves W1 and W2 may respectively be sine waves or squared sine waves.

For Example, the Sine waves W1 and W2 may respectively be squared sine waves. The sine wave W1 is shown in Formula (1). The sine wave W2 is shown in Formula (2).

$$W 1 = R \times {sin}^{2} ( 2 π \times F 1 \times t ) \qquad Formula ( 1 )$$

$$W 2 = R \times {sin}^{2} ( 2 π \times F 2 \times t ) \qquad Formula ( 2 )$$

“R” is amplitude. “t” is time.

The voltage value VT may be adjusted based on the design of the vibrator 110. For example, the voltage value VT may be between 0.2R and 0.8R.

Please refer to FIG. 1, FIG. 2 and FIG. 3B, FIG. 3B is a schematic diagram illustrating the deposition of the arrange of the vibrator according to an embodiment of the disclosure. In the embodiment, the vibrating reed 112_1 of the vibrator 110 is suitable for generating displacement to vibrate the objects OBJ1 and OBJ3. The Vibrating reed 112_2 of the vibrator 110 is suitable for generating displacement to vibrate the objects OBJ2 and OBJ4 according to the driving signal SD.

Please refer to FIG. 1 and FIG. 3C, FIG. 3C is a schematic diagram illustrating the deposition of the arrange of the vibrator according to an embodiment of the disclosure. In the embodiment, the vibrator 110 may be a Linear Resonant Actuator (LRA) or an Eccentric Rotating Mass (ERM) motor. In the embodiment, the vibrator 110 is suitable for generating displacement to vibrate the object OBJ1 according to the driving signal SD.

Please refer to FIG. 1 and FIG. 3D, FIG. 3D is a schematic diagram illustrating the deposition of the arrange of the vibrator according to an embodiment of the disclosure. In the embodiment, the vibrator 110 may be a linear resonant actuator (LRA) or an eccentric rotating mass (ERM) motor or a piezoelectric actuator. In the embodiment, the vibrator 110 is suitable for generating displacement to vibrate the objects OBJ1 and OBJ2 according to the driving signal SD. The objects OBJ1 and OBJ2 are located on the same side of the vibrator 110.

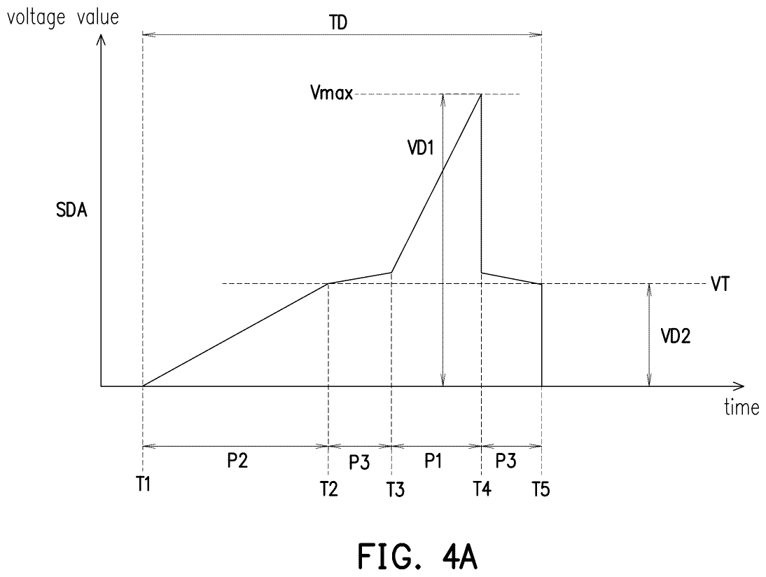

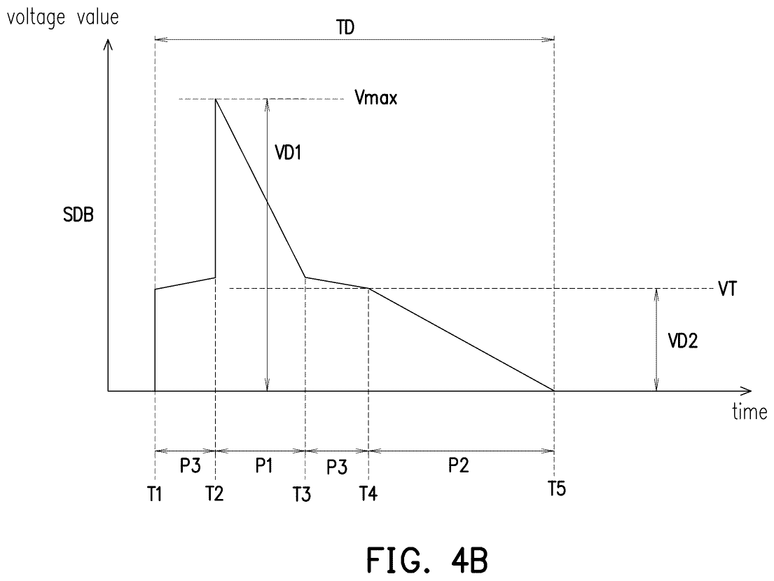

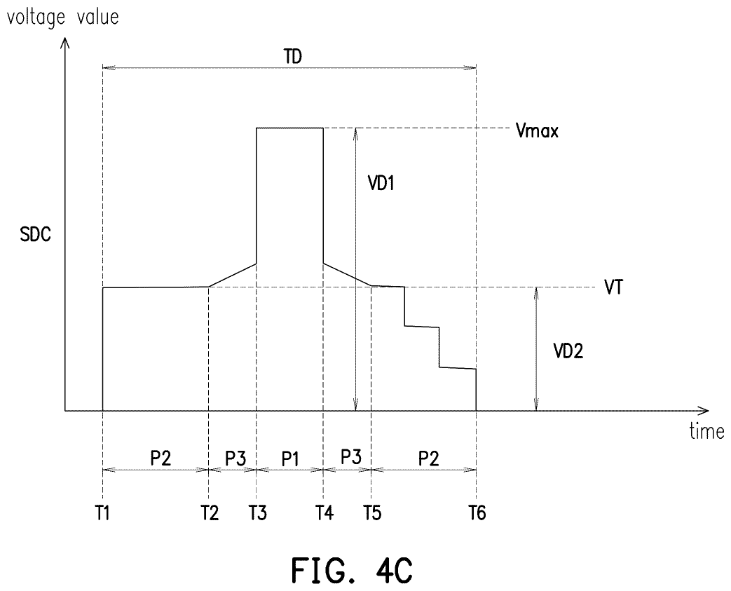

Please refer to FIG. 4A, FIG. 4A is a waveform diagram of the driving signal according to an embodiment of the disclosure. In the embodiment, the driving signal SDA includes the first part P1, the second part P2 and the third part P3. The first part P1 and the second part P2 are triangular waves respectively. For example, the first part P1 and the second part P2 are sawtooth waves respectively. The first part P1 includes the maximum absolute voltage value. The maximum absolute voltage value is, for example, the absolute value of the maximum voltage value Vmax of the driving signal SDA (for example, |Vmax|). The second part P2 includes the minimum absolute voltage value. The minimum absolute voltage value is, for example, the absolute value of the minimum voltage value of the driving signal SDA. For example, the minimum voltage value is approximately equal to 0 volt, but the disclosure is not limited thereto. Within the same time interval TD, the relative voltage variation VD1 of the first part P1 is greater than the relative voltage variation VD2 of the second part P2.

In the embodiment, the second part P2 of the driving signal SDA is provided from the time point T1 to the time point T2. The third part P3 of the driving signal SDA is provided from the time point T2 to the time point T3. The first part P1 of the driving signal SDA is provided from the time point T3 to the time point T4. The third part P3 of the driving signal SDA is provided from the time point T4 to the time point T5.

In some embodiments, one of the first part P1 and the second part P2 may be replaced by one of the sine wave, the squared sine wave and the step wave.

Please refer to FIG. 4B, FIG. 4B is a waveform diagram of the driving signal according to an embodiment of the disclosure. In the embodiment, the driving signal SDB includes the first part P1, the second part P2 and the third part P3. The first part P1 and the second part P2 are triangular waves respectively. For example, the first part P1 and the second part P2 are sawtooth waves respectively. Different from the driving signal SDA shown in FIG. 4A, the third part P3 of the driving signal SDB is provided from the time point T1 to the time point T2. The first part P1 of the driving signal SDB is provided from the time point T2 to the time point T3. The third part P3 of the driving signal SDB is provided from the time point T3 to the time point T4. The second part P2 of the driving signal SDB is provided from the time point T4 to the time point T5.

Please refer to FIG. 4C, FIG. 4C is a waveform diagram of the driving signal according to an embodiment of the disclosure. In the embodiment, the driving signal SDC includes the first part P1, the second part P2 and the third part P3. The first part P1 and the second part P2 are step waves respectively. The first part P1 includes the maximum absolute voltage value. The maximum absolute voltage value is, for example, the absolute value of the maximum voltage value Vmax of the driving signal SDC (for example, |Vmax|). The second part P2 includes the minimum absolute voltage value. The minimum absolute voltage value is, for example, the absolute value of the minimum voltage value of the driving signal SDC. For example, the minimum voltage value Vmin is approximately equal to 0 volt, but the disclosure is not limited thereto. Within the same time interval TD, the relative voltage variation VD1 of the first part P1 is greater than the relative voltage variation VD2 of the second part P2.

In the embodiment, the second part P2 of the driving signal SDC is provided from the time point T1 to the time point T2. The second part P2 between the time point T1 and the time point T2 is, for example, a step wave with a single step (but the disclosure is not limited to the number of steps in the second part P2). The third part P3 of the driving signal SDC is provided from the time point T2 to the time point T3. The first part P1 of the driving signal SDC is provided from the time point T3 to the time point T4. The first part P1 between the time point T3 and the time point T4 is, for example, a step wave with a single step (but the disclosure is not limited to the number of steps in the second part P2). The third part P3 of the driving signal SDC is provided from the time point T4 to the time point T5. The second part P2 of the driving signal SDC is provided from the time point T5 to the time point T6. The second part P2 between the time point T5 and the time point T6 is, for example, a step wave with 3 steps.

In some embodiments, one of the first part P1 and the second part P2 may be replaced with one of the sine wave, the squared sine wave and the triangular wave.

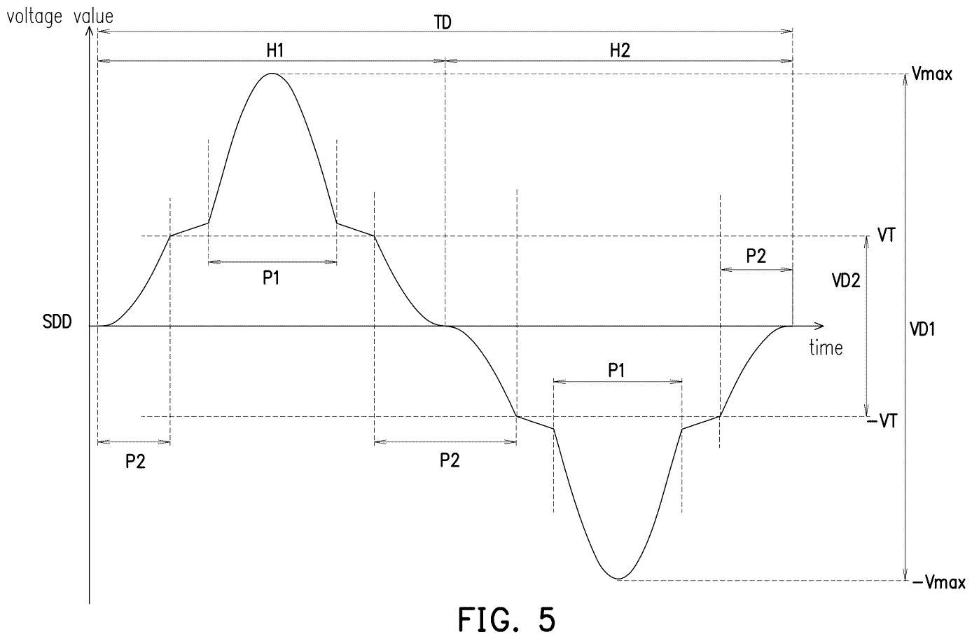

Please refer to FIG. 5, FIG. 5 is a waveform diagram of the driving signal according to an embodiment of the disclosure. In the embodiment, the driving signal SDD includes a positive half wave H1 and a negative half wave H2. The waveform of the positive half wave H1 is similar to the driving signal SD shown in FIG. 1, so it will not be repeated here. The waveform of the negative half wave H2 is similar to an inverted signal of the driving signal SD shown in FIG. 1.

In the embodiment, the driving signal SDD includes a first part P1 and a second part P2. Within the same time interval TD, the relative voltage variation VD1 of the first part P1 is greater than the relative voltage variation VD2 of the second part P2. The relative voltage variation VD1 is approximately equal to twice the maximum voltage value Vmax. The relative voltage variation VD2 is approximately equal to twice the voltage value VT.

In the embodiment, the first part P1 may be one of the sine wave, the squared sine wave, a triangular wave and the step wave. The second part P2 may be one of the sine wave, the squared sine wave, the triangular wave and the step wave.

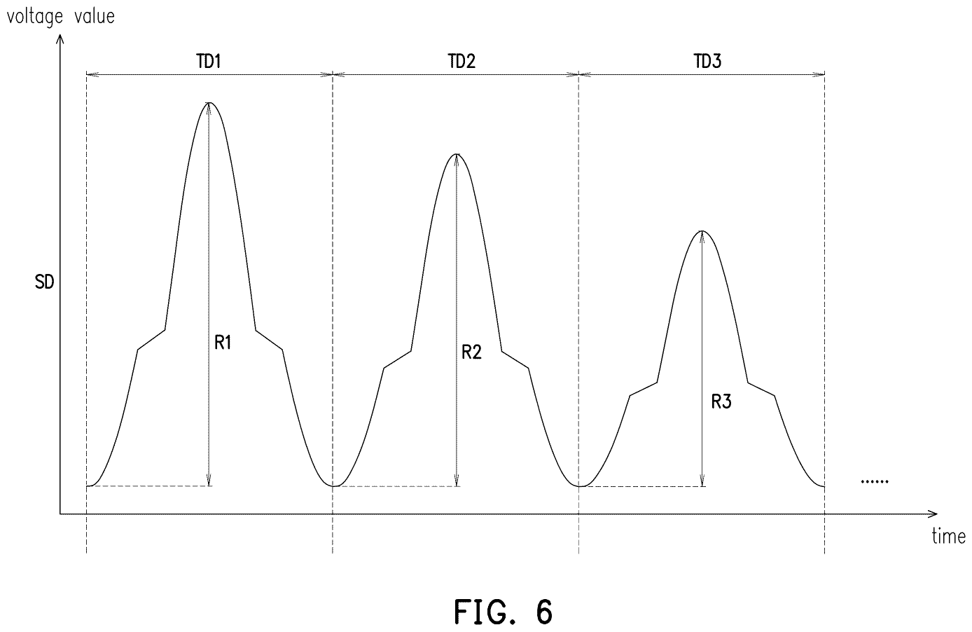

Please refer to FIG. 1 and FIG. 6, FIG. 6 is a waveform diagram of the driving signal according to an embodiment of the disclosure. FIG. 6 shows multiple periods of the driving signal SD. It should be noted that an amplitude of the driving signal SD decreases over time. In the embodiment, in the time interval TD1, the driving signal SD has an amplitude R1. In the time interval TD2, the driving signal SD has an amplitude R2. In the Time interval TD3, the driving signal SD has an Amplitude R3, and so on. The amplitude R2 is smaller than the amplitude R1. The amplitude R3 is smaller than the amplitude R2. Therefore, the vibration generated by the vibrator 110 may weaken over time. In this way, the electronic device 100 provides a rich touch vibration experience.

In the embodiment, the relative voltage variations VD1 and VD2 respectively decrease over time.

In some embodiments, the relative voltage variation VD1 decreases over time. The relative voltage variation VD2, however, does not decrease over time.

In the embodiment, the first part P1 may be one of a sine wave, a squared sine wave, a triangular wave and a step wave. The second part P2 may be one of a sine wave, a squared sine wave, a triangular wave and a step wave.

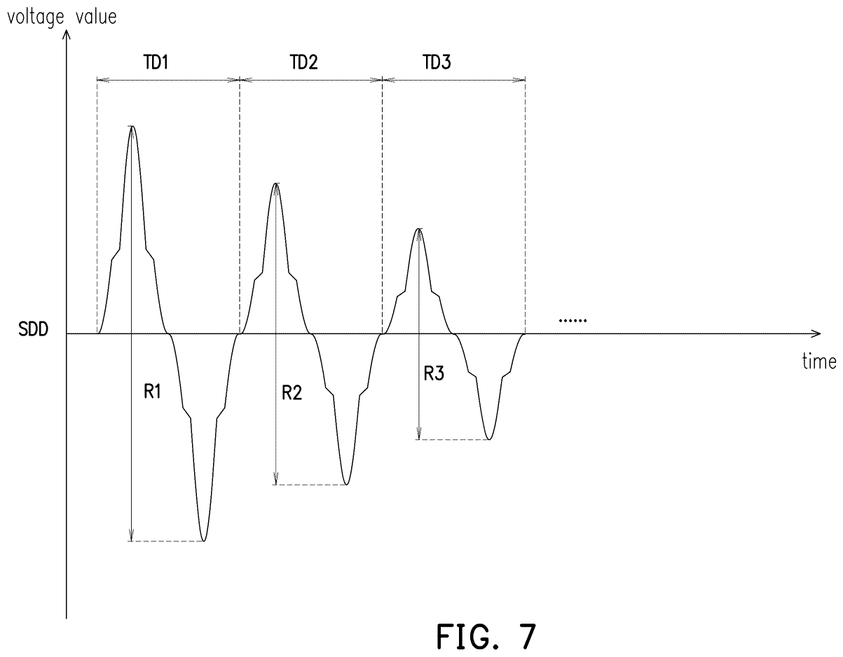

Please refer to FIG. 1, FIG. 5 and FIG. 7, FIG. 7 is a waveform diagram of the driving signal according to an embodiment of the disclosure. FIG. 7 shows multiple periods of the driving signal SDD. It should be noted that the amplitude of the driving signal SDD decreases over time. In the embodiment, in the time interval TD1, the driving signal SDD has the amplitude R1. In the time interval TD2, the driving signal SDD has the amplitude R2. In the time interval TD3, the driving signal SDD has the amplitude R3, and so on. The amplitude R2 is smaller than the amplitude R1. The amplitude R3 is smaller than the amplitude R2. Therefore, the vibration generated by the vibrator 110 may weaken over time. In this way, the electronic device 100 provides a rich touch vibration experience.

In the embodiment, the relative voltage variation s VD1 and VD2 respectively decrease over time.

In some embodiments, the relative voltage variation VD1 decreases over time. The relative voltage variation VD2 does not decrease over time.

In the embodiment, the first part P1 may be one of the sine wave, the squared sine wave, the triangular wave and the step wave. The second part P2 may be one of the sine wave, the squared sine wave, the triangular wave and the step wave.

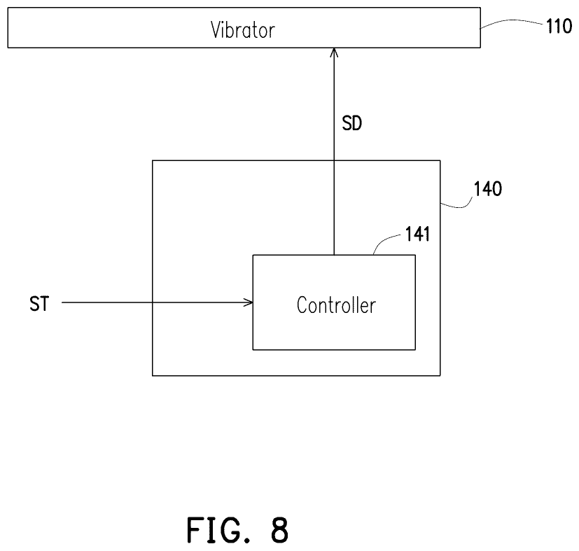

Please refer to FIG. 8, FIG. 8 is a schematic diagram of the vibrator and control circuit according to an embodiment of the disclosure. In the embodiment, the control circuit 140 includes a controller 141. The controller 141 is electrically connected to the vibrator 110. The controller 141 converts the touch signal ST into the driving signal SD. The controller 141 may adjust the amplitude, frequency and duty cycle of the driving signal SD according to the touch signal ST. Therefore, the controller 141 may perform adjustment on the driving signal SD similar to one of Pulse Width Modulation (PWM) and Pulse Amplitude Modulation (PAM).

In the embodiment, the driving signal SD includes at least a first part P1 and a second part P2. The first part P1 may be one of the sine wave, the squared sine wave, the triangular wave and the step wave. The second part P2 may be one of the sine wave, the squared Sine wave, the triangular wave and the step wave.

In the embodiment, the controller 141 may be, for example, a central processing unit (CPU), or other programmable general-purpose or special-purpose microprocessor, digital signal processor (DSP), programmable controller, application specific integrated circuits (ASIC), programmable logic device (PLD), or other similar devices or combinations of these devices, which can load and execute computer programs.

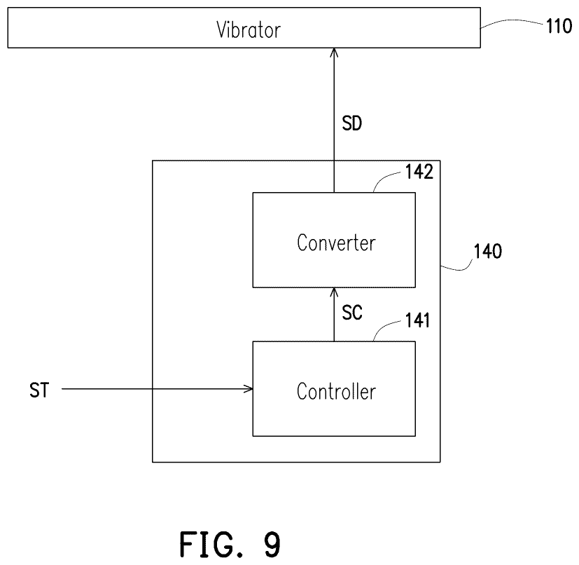

Please refer to FIG. 9, FIG. 9 is a schematic diagram of the vibrator and control circuit according to an embodiment of the disclosure. In the embodiment, the Control Circuit 140 includes a controller 141 and a converter 142. The controller 141 is electrically connected to the vibrator 110. The controller 141 generates a vibration control signal SC according to the touch signal ST. The converter 142 is electrically connected to the controller 141 and the vibrator 110. The converter 142 converts the vibration control signal SC into the driving signal SD.

In the embodiment, the vibration control signal SC is one of a voltage value signal, a temperature value signal and a current value signal. The vibration control signal SC may be a digital control signal. The converter 142 may be an Analog-to-Digital converter (ADC). The converter 142 may convert the vibration control signal SC into the driving signal SD having an analog format.

In the embodiment, the driving signal SD includes at least the first part P1 and the second part P2. The first part P1 may be one of the sine wave, the squared sine wave, the triangular wave and the step wave. The second part P2 may be one of the sine wave, the squared sine wave, the triangular wave and the step wave.

Based on above, the driving signal includes the first part and the second part. The second part determines the level of collision between the vibrator and the object in the electronic device. The first part determines the amplitude of vibration of the vibrator. The relative voltage variation of the second part is smaller than the relative voltage variation of the first part. The level of collision between the vibrator and the object is limited by the second part. Therefore, the noise generated by the electronic device s itself due to the vibration of the vibrator can be reduced. In this way, experience of the electronic device for the user may be improved.

Finally, it should be noted that: the above embodiments are only used to illustrate the technical solutions of this Disclosure, and are not intended to limit them; although the Disclosure has been described in detail with reference to the foregoing embodiments, those skilled in the art should understand: they can still modify the technical solutions described in the foregoing embodiments, or make equivalent replacements to part or all of the technical features; and these modifications or replacements do not make the essence of the corresponding technical solutions deviate from the scope of the technical solutions of the embodiments of this Disclosure.

What is claimed is:

1. An electronic device, comprising:
at least one vibrator;
a display panel, arranged on the at least one vibrator;
a touch element, arranged on the display panel; and
a control circuit, electrically connected to the at least one vibrator and the touch element, and configured to generate a driving signal according to a touch signal provided by the touch element,
wherein the at least one vibrator generates vibration according to a driving signal generated by the touch signal, and
wherein the driving signal includes a first part and a second part, the first part comprises a maximum absolute voltage value, the second part comprises a minimum absolute voltage value, in a same time interval, a relative voltage variation of the first part is greater than a relative voltage variation of the second part.

2. The electronic device according to claim 1, wherein a first frequency of the first part is higher than a second frequency of the second part.

3. The electronic device according to claim 1, wherein the first part includes one of a sine wave, a squared sine wave, a triangle wave and a step wave.

4. The electronic device according to claim 1, wherein the second part includes one of a sine wave, a squared sine wave, a triangle wave and a step wave.

5. The electronic device according to claim 1, wherein:
the driving signal further comprises a third part, and
the third part is a connecting part located between the first part and the second part.

6. The electronic device according to claim 5, wherein a slope of the voltage value of the third part with respect to time is equal to 0.

7. The electronic device according to claim 5, wherein a slope of the voltage value of the third part with respect to time is not equal to 0.

8. The electronic device according to claim 1, wherein an amplitude of the driving signal reduces with time.

9. The electronic device according to claim 1, wherein an amplitude of the driving signal does not reduce with time.

10. The electronic device according to claim 1, wherein each of the at least one vibrator comprises:
a piezoelectric element, configured to extend and contract along a first direction according to the driving signal; and
a vibrating reed, fixed at two terminals on one side of the piezoelectric element, thereby vibrating along a second direction according to the driving signal.

11. The electronic device according to claim 1, wherein each of the at least one vibrator is one of a linear resonant actuator, an eccentric rotating mass motor and a piezoelectric actuator.

12. The electronic device according to claim 1, wherein when the voltage value of the second part rises slowly, the noise caused by a collision between the at least one vibrator and an object of the electronic device is reduced.

13. The electronic device according to claim 1, wherein the maximum absolute voltage value of the first part determines an amount of vibration of the electronic device.

14. The electronic device according to claim 1, wherein the driving signal comprises a positive half wave.

15. The electronic device according to claim 1, wherein the driving signal comprises a positive half wave and a negative half wave.

16. The electronic device according to claim 1, wherein the control circuit comprises:
a controller, electrically connected to the at least one vibrator, and configured to convert the touch signal into the driving signal.

17. The electronic device according to claim 1, wherein the control circuit comprises:
a controller, configured to generate a vibration control signal according to the touch signal; and
a converter, electrically connected to the controller and the at least one vibrator, and configured to convert the vibration control signal into the driving signal.

18. The electronic device according to claim 17, wherein the vibration control signal is one of a voltage value signal, a temperature value signal and a current value signal.

19. The electronic device according to claim 17, wherein the vibration control signal is a digital control signal.

20. The electronic device according to claim 17, wherein the converter is a digital-to-analog converter.
